(19) United States
(12) Patent Application Publication
(10) Pub. No.: US 2016/0295893 A1
(43) Pub. Date: Oct. 13, 2016

(54) HIGH INTENSITY SWEETENER COMPOSITION

(71) Applicant: Tate & Lyle Technology Limited, London (GB)

(72) Inventor: Nathalie Violette SOMMIER, Villeneuve d'Ascq (FR)

(73) Assignee: Tate & Lyle Technology Limited, London (GB)

(21) Appl. No.: 15/035,975

(22) PCT Filed: Nov. 12, 2014
(86) PCT No.: PCT/GB2014/053358

§ 371 Date: May 11, 2016

(30) Foreign Application Priority Data
Nov. 13, 2013 (GB) 1320030.8

(51) Int. Cl. A23L 1/216; A23L 2/60

(52) U.S. Cl. CPC A23L 1/2367; A23L 2/60; A23L 1/0017; A23V 2002/00

(57) ABSTRACT

A sweetener composition is described comprising agglomerated particles. The agglomerated particles include one or more core particles which consist of a first carrier substance having a relative sweetness of less than 0.3 and present in an amount of from 45 to 10 wt % (based on the weight of the composition). A coating is disposed around the one or more core particles, the coating comprising a second carrier substance having a relative sweetness of less than 0.3 and present in an amount of from 45 to 10 wt % (based on the composition weight) and a high intensity sweetener having a relative sweetness of greater than 100 and present in an amount of from 10 to 80 wt % (based on the composition weight).

### TECHNICAL FIELD

The present invention relates to sweetener compositions comprising a high intensity sweetener, in particular sucralose.

### BACKGROUND

Sucralose is a high intensity sweetener having the systematic name 4,1′,6′-trichloro-4,1′,6′-trideoxy-galacto-sucrose. It has a relative sweetness of about 600. Sucralose and other high intensity sweeteners are often formulated with other materials in order to provide sweetener compositions that are more easily handled. The other materials are generally either carriers which contribute little to the overall sweetness of the composition, or other sweeteners which do contribute significantly to the overall sweetness of the composition. Other materials such as binders can also be included in the compositions.

Such sweetener compositions can be conceptually divided into two types: tabletop products which are intended for consumer use, and ingredient products which are intended for food manufacture. Tabletop products are generally designed to replace sucrose and therefore have a similar sweetness intensity (on a volume-for-volume basis). Typically they range from “spoon-for-spoon” products designed to have a similar sweetness intensity to sucrose to “half-spoon” products designed to have a sweetness intensity of about twice that of sucrose, on a volume-for-volume basis. On the other hand, ingredient products do not require this characteristic of volume-for-volume sweetness equivalency, and therefore generally have much higher levels of the high intensity sweetener.

Examples of sucralose-containing tabletop products can be found in the following patent documents.

GB 1,543,167 discloses in Example 6 a bulked, spoon-for-spoon product comprising spray-dried sucralose and maltodextrin and having a bulk density of 0.2 gcm⁻³.

U.S. Pat. No. 5,061,320 discloses a spoon-for-spoon product comprising sucrose and sucralose, produced by a foam spray drying and agglomeration process.

WO2007/133374 and WO2007/133343 disclose spoon-for-spoon products having a sparkling appearance, including sucrose, sucralose and maltodextrin, and prepared by an agglomeration process.

WO 2005/103304 discloses a sucralose composition comprising granules having a core including a nutritive sweetener and coated in a layer including sucralose.

WO 2006/115680 discloses sweetening compositions comprising a nutritive sweetener in intimate contact with a high intensity sweetener.

WO 98/02585 and WO2007/110645 disclose agglomerated sweetener compositions comprising sucralose and maltodextrin, primarily in the context of spoon-for-spoon products.

Examples of sucralose product forms intended for ingredient use can be found in the following patent documents.

EP 0267809 A discloses a sweetener concentrate of spray-dried sucralose and maltodextrin.

U.S. Pat. No. 5,932,720 discloses a solid crystalline sucralose product form prepared by an agglomeration-type process.

WO2004/112506 discloses a sucralose product form produced by compacting a sucralose-containing feed material and then grinding the compacted material to form granules. The granules may include a binder.

U.S. Pat. No. 7,750,146 discloses an agglomerated sucralose product.

EP 0472500 A discloses a freeze-dried mixture of sucralose and a stabilizing agent that may be a bulking agent.

EP 0457724 A discloses a mixture of sucralose and a stabilising agent.

WO 2008/144063 discloses a method of freeze-drying sucralose to form beads.

In some of these product forms a carrier is included; in others the product form contains only sucralose.

Sucralose in unformulated solid form is known to be susceptible to issues of stability at elevated temperatures. It is desirable that a sweetener composition mitigate any such issues.

There remains a need for further formulations of high intensity sweeteners for ingredient use, in particular for sucralose-containing formulations. In particular, different food ingredient applications often require specific particle sizes for optimum results. Not all particle sizes are readily achievable using the prior art ingredient product forms described above. There remains a particular need to readily attain compositions with particle size in the range between 200 and 400 μm.

### SUMMARY

According to a first aspect of the present invention, there is provided a sweetener composition comprising agglomerated particles, each particle including:

one or more core particles, each consisting of a first carrier substance having a relative sweetness of less than 0.3 and present in an amount of from 45 to 10% (preferably 45 to 25%) by weight of the composition;

a coating disposed around the one or more core particles, the coating comprising:

a second carrier substance having a relative sweetness of less than 0.3 and present in an amount of from 45 to 10% (preferably 45 to 25%) by weight of the composition; and

a high intensity sweetener having a relative sweetness of greater than 100 and present in an amount of from 10 to 80% (preferably 10 to 50%) by weight of the composition.

According to a second aspect of the present invention, there is provided a method of making a sweetener composition according to the first aspect of the invention described above, the method comprising:
preparing a coating solution comprising the second carrier substance and the high intensity sweetener dissolved in water;
applying the coating solution to the core particles under conditions which moisten the core particles with the coating solution; and
drying the resulting mixture to afford a sweetener composition according to the first aspect of the invention described above.

In a further aspect, the high intensity sweetener may be sucralose.

In a further aspect, the first carrier substance may be maltodextrin.

In a further aspect, the second carrier substance may be maltodextrin.

In a further aspect, the mean particle size of the agglomerated particles may be between 200 and 400 μm.

In a further aspect, the composition may contain water in an amount of less than 8% by weight of the composition.

In a further aspect, the coating may further comprise a buffer. In this case, the coating solution in the above method according to the second aspect of the invention may comprise a buffer.

In a further aspect, the invention provides a food product or beverage product incorporating a sweetener composition as defined herein. In some embodiments, the food or beverage product is a food precursor or a beverage precursor, preferably in powdered form. In some embodiments, the invention provides a beverage product incorporating a sweetener composition as defined herein, preferably a beverage precursor, suitably in powdered form.

In a further aspect, the invention provides the use of a sweetener composition as defined herein in a food product or beverage product. In some embodiments, the food or beverage product is a food precursor or a beverage precursor, preferably in powdered form. In some embodiments, the invention provides the use of a sweetener composition as defined herein in a beverage product, preferably a beverage precursor, suitably in powdered form.

In a further aspect, the invention provides a method of making a food product or beverage product incorporating a sweetener composition as defined herein. In some embodiments, the food or beverage product is a food precursor or a beverage precursor, preferably in powdered form. In some embodiments, the invention provides a method of making a beverage product incorporating a sweetener composition as defined herein, preferably a beverage precursor, suitably in powdered form.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows the effect of the invention on sample stability at 50° C. The graph shows pH as a function of time for pure sucralose, a product according to the invention, and a product prepared by an analogous process to the invention wherein the sucralose is not completely dissolved in the coating solution.

FIG. 2 shows the effect of the invention on sample stability at 50° C. The graph shows colour (whiteness and yellowness) as a function of time for a product according to the invention, and a product prepared by an analogous process to the invention wherein the sucralose is not completely dissolved in the coating solution.

FIG. 3 shows the effect of the invention on sample stability at 50° C. The graph shows 4-chlorogalactose generation as a function of time for a product according to the invention, and a product prepared by an analogous process to the invention wherein the sucralose is not completely dissolved in the coating solution.

FIG. 4 shows the effect of the invention on sample stability at 50° C. The graph shows pH as a function of time for three products according to the invention.

FIG. 5 shows the effect of the invention on sample stability at 50° C. The graph shows colour (whiteness and yellowness) as a function of time for three products according to the invention.

FIG. 6 shows the effect of the invention on sample stability at 50° C. The graph shows 4-chlorogalactose generation as a function of time for three products according to the invention.

FIG. 7 shows the effect of the invention on sample stability over a 12 week testing period at 50° C. The graph shows sucralose content as a function of time for a product according to the invention.

FIG. 8 shows the effect of the invention on sample stability over a 12 week testing period at 50° C. The graph shows colour (whiteness and yellowness) as a function of time for a product according to the invention.

FIG. 9 shows the effect of the invention on the stability of a powdered soft drink (PSD) beverage precursor over a 20 week testing period at 50° C. The graph shows sucralose content as a function of time for a product according to the invention.

### DETAILED DESCRIPTION

As described above, the present invention provides in one aspect a sweetener composition comprising agglomerated particles, each particle including:

one or more core particles, each consisting of a first carrier substance having a relative sweetness of less than 0.3 and present in an amount of from 45 to 10% or from 45 to 25% by weight of the composition;

a coating disposed around the one or more core particles, the coating comprising:

a second carrier substance having a relative sweetness of less than 0.3 and present in an amount of from 45 to 10% or from 45 to 25% by weight of the composition; and

a high intensity sweetener having a relative sweetness of greater than 100 and present in an amount of from 10 to 80% or from 10 to 50% by weight of the composition.

As used herein, the “relative sweetness” of a substance represents how many times sweeter the substance is compared to sucrose. High intensity sweeteners as defined herein are at least 100 times sweeter than sucrose while products with a relative sweetness of less than 1 are less sweet than sucrose. By definition, the relative sweetness of sucrose is 1.

As used herein, “high intensity sweetener” refers to a substance that is greatly sweeter than sucrose, for example one hundred times sweeter or more, so that the relative sweetness is more than 100.

In some embodiments, the agglomerated particles may consist of the one or more core particles and the coating disposed around the one or more core particles. According to these embodiments, the agglomerated particles contain only the core and coating around the core, i.e. they contain no other layers.

In some embodiments, the high intensity sweetener comprises or consists of sucralose. The preferred high intensity sweetener is sucralose. Other high intensity sweeteners that can be used include: monkfruit extract (also known as luo han guo or rakanka); stevia extract; mogroside V; steviol glycosides including stevioside; rebaudiosides including rebaudioside A, rebaudioside B, rebaudioside D and rebaudioside M; aspartame; neotame; saccharin; and acesulfame-K. These can be used alone, or in combination with each other or with sucralose.

In some embodiments, the high intensity sweetener is a synthetic sweetener. Example synthetic sweeteners include aspartame, neotame, saccharin, sucralose and acesulfame-K.

According to the present invention, the majority of the sweetness of the composition derives from the high intensity sweetener. Accordingly, the first carrier substance and the second carrier substance are of relatively low sweetness and each has a relative sweetness of less than 0.3.

The first carrier substance and the second carrier substance may be the same or different, and each may be maltodextrin, starch, soluble glucose fibre, or polydextrose. Maltodextrin is preferred. The maltodextrin can be, for example, a 6 DE (dextrose equivalent) maltodextrin or a 10 DE maltodextrin. In general, the DE of the maltodextrin may range between 6 and 18, or between 6 and 12. A protein can also be used as the first and/or second carrier substance.

The first carrier substance forms a core and is present in an amount of from 45 to 10% or from 45 to 25% by weight of the composition. The second carrier substance, present in an amount of from 45 to 10% or from 45 to 25% by weight of the composition, and the high intensity sweetener, present in an amount of from 10 to 80% or from 10 to 50% by weight of the composition, are disposed around the core. In some embodiments, the agglomerated particles are substantially or wholly free from components of intermediate sweetness; that is, components which have a relative sweetness in the range of 0.5, 0.6, 0.7 or 0.75 to 5, 10, 20, 50 or 100 (for example, 0.5 to 10 or 0.7 to 5). In other words, in some embodiments the agglomerated particles comprise substantially no components of intermediate sweetness; in some embodiments the agglomerated particles do not include any components of intermediate sweetness. In particular, in some embodiments the agglomerated particles substantially do not include sucrose. In some embodiments, the agglomerated particles comprise no sucrose.

In some embodiments, the coating may substantially consist of or consist of the second carrier substance, the high intensity sweetener, and optionally a buffer and/or water (as discussed below). In some embodiments, the coating may substantially consist of or consist of the second carrier substance, the high intensity sweetener and water.

In some embodiments, the sweetener composition is substantially or wholly free from (i.e. does not include any) particles of intermediate sweetness; that is, particles which have a relative sweetness in the range of about 0.5, 0.6, 0.7 or 0.75 to 5, 10, 20, 50 or 100 (for example, 0.5 to 10 or 0.7 to 5). In other words, the composition comprises substantially no particles of intermediate sweetness, or does not include any particles of intermediate sweetness. In particular, in some embodiments, the sweetener composition is substantially or wholly free from sucrose particles.

In some embodiments, the sweetener composition is substantially or wholly free from (i.e. does not include any) compounds or components of intermediate sweetness; that is, compounds or components that have a relative sweetness in the range of about 0.5, 0.6, 0.7 or 0.75 to 5, 10, 20, 50 or 100 (for example, 0.5 to 10 or 0.7 to 5). In other words, the composition comprises substantially no compounds or components of intermediate sweetness, or does not include any compounds or components of intermediate sweetness. In particular, in some embodiments, the sweetener composition is substantially or wholly free from sucrose, i.e. it comprises substantially no sucrose or it does not include sucrose.

In some embodiments, the sweetener composition may comprise at least about 50 wt %, 60 wt %, 70 wt %, 80 wt %, 90 wt %, 95 wt %, 96 wt %, 97 wt %, 98 wt %, 99 wt % or 100 wt % of the agglomerated particles defined herein. The sweetener composition may substantially consist of or may consist of the agglomerated particles defined herein.

The core particles composed of the first carrier substance typically have a mean particle size in the range of from 50 μm to 300 μm. In some embodiments the mean particle size of the core particles may be from 100 μm to 150 μm. In particular when the first carrier substance is maltodextrin, the maltodextrin of the core particles may have a mean particle size of from 100 μm to 150 μm.

The coating comprising the second carrier substance and the high intensity sweetener is disposed around one or more core particles. The coating is conveniently formed by an agglomeration process. Such a process may include, for example, preparing a coating solution comprising the second carrier substance and the high intensity sweetener dissolved in water; applying the coating solution to the core particles under conditions which moisten the core particles with the coating solution; and drying the resulting mixture.

The agglomerated particles may contain water in an amount of less than 8% by weight of the particles. In an agglomeration process for forming the composition by applying a coating, such as set out in the preceding paragraph, the mixture may be dried to a moisture content of less than 8% by weight of the particle. For example, the agglomerated particles may contain water in an amount of from 3 to 7% by weight of the particles, and the mixture may be dried to a moisture content of from 3 to 7% by weight of the particles.

The composition may contain water in an amount of less than 8% by weight of the composition. In an agglomeration process for forming the composition by applying a coating, such as set out in the earlier paragraph, the mixture may be dried to a moisture content of less than 8% by weight of the composition. For example, the composition may contain water in an amount of from 3 to 7% by weight of the composition, and the mixture may be dried to a moisture content of from 3 to 7% by weight of the composition.

The mean particle size of the agglomerated particles may be between 200 and 400 μm. The present invention is a convenient way to provide an agglomerated sweetener composition wherein the mean particle size is in the range of between 200 and 400 μm.

In the agglomeration process that can be used to prepare sweetener compositions according to the present invention, the agglomeration conditions can be varied to give compositions of varying bulk density. The bulk density can be lower, for example in the region of 320 to 480 g/l, or higher, for example in the region of 600 to 650 g/l. Overall, the bulk density can vary from 300 to 700 g/l.

In general, agglomeration processes to achieve compositions according to the present invention can be achieved using agglomeration techniques that are known in the art. Specific conditions are shown in the Examples. In general, any wet granulation or agglomeration technique known in the art can be employed. Such techniques generally have in common the formation of granules by addition of a binder onto a powder bed which is under the influence of an impeller (in the case of a high shear granulator), screws (such as in the case of a twin screw granulator) or air (in the case of a fluidised bed granulator). Any of these techniques can be used in the present invention. Moreover, the operation can be batch or continuous.

Fluid bed granulation is particularly suitable for use in the present invention. In fluid bed granulation as applied to present invention, the core particles in powder form are fluidised, and the coating solution is sprayed onto the fluidised particles. The agglomerate growth results from the repetition of different steps (wetting of the particle surface, particles collision and bridging, and drying). The processing conditions can be varied to adjust the properties (such as particle size, bulk density, and so on) of the final agglomerated sweetener composition. Thus, the desired bulk density and particle size can be achieved by suitable adjustment of the process parameters. A higher ratio of core particles to coating will give a higher bulk density. Also, the bulk density and particle size can be varied by adjusting the air flow rate used to fluidise the core particles, and the temperature of the air used to fluidise the core particles.

Fluid bed processors can be batch or continuous, and vary in size and capacity. On a laboratory scale, suitable batch equipment is the Lodige LFP Mini 2. On a pilot scale, suitable equipment that can be used in continuous operation is the Glatt GF20. Production scale fluid bed processors that are suitable for use in the present invention, particularly in continuous operation, are also manufactured by Glatt.

The coating in the agglomerated sweetening composition according to the present invention may include a buffer. The buffer is conveniently included by being dissolved in the coating solution. The buffer is preferably a food acceptable salt of a weak acid. The salt will typically be an alkali metal salt. Suitable buffers are disclosed in WO 2008/144063 (relating to a freeze-dried sucralose form). The weak acids may include phosphoric acid, carbonic acid, and carboxylic acids. Exemplary carboxylic acids include formic, acetic, propionic, maleic, fumaric, and benzoic acid. Suitable specific compounds include sodium citrate or potassium citrate; sodium phosphate or potassium phosphate; amino acid bases such as arginine and lysine; sodium tartrate or potassium tartrate; sodium adipate or potassium adipate; sodium malate or potassium malate; sodium phosphate monobasic and sodium phosphate dibasic. Also suitable are sodium or potassium ascorbate, caprylate, gluconate, lactate, and sorbate.

When the high intensity sweetener employed is sucralose, it has been surprisingly found that the thermal stability of the composition is increased in the sweetener compositions of the present invention. In particular, the stability is increased compared with the stability of pure sucralose (for example pure sucralose in micronized form, or pure sucralose in granular form). The stability is also increased compared with products prepared in a manner analogous to the agglomeration methods of the present invention, but wherein the sucralose is not completely dissolved in the coating solution. In some embodiments, the agglomerates formed according to methods of the invention, in which all of the sucralose is dissolved in the coating solution, are stable for at least 12 weeks when stored at 50° C. For example, as shown in the Examples, an agglomerated sweetening composition made of sucralose and maltodextrin in proportions 30:70 by weight, in which only 50% of the whole sucralose was dissolved in the coating solution showed some sucralose degradation after 4 to 6 days of storage at 50° C. This is only a slight improvement compared with the stability of pure sucralose. On the other hand, agglomerates with the same composition but in which all of the sucralose is dissolved in the coating solution are stable for at least 17 weeks at the same temperature. To achieve this stabilisation therefore, it is apparently required that the sucralose be substantially completely dissolved in the coating solution.

A further aspect of the present invention provides a food product incorporating the sweetener composition of the invention or a beverage product incorporating the sweetener composition of the invention. The food product may be a food (i.e. ready for consumer consumption) or it may be a food precursor (i.e. a product which the consumer processes into a food). The beverage product may be a beverage (i.e. ready for consumer consumption) or it may be a beverage precursor (i.e. a product which the consumer processes into a beverage). Food and beverage precursors may be provided in the form of a liquid concentrate, or in solid form, suitably as a tablet or powder. Food and beverage precursors in powdered form are preferred.

Non-limiting examples of a food product include a confectionary product (including, but not limited to, jelly candies, hard candies and gums), a dessert product such as yogurt (including, but not limited to, full fat, reduced fat and fat-free dairy yoghurts, as well non-dairy and lactose-free yoghurts and frozen equivalents of all of these), frozen desserts (including, but not limited to, frozen dairy desserts such as ice-cream—including regular ice cream, soft-serve ice cream and all other types of ice cream—and frozen non-dairy desserts such as non-dairy ice cream, sorbet and the like), powdered dessert mixes (including custard powder and other dessert precursors that can be processed into a dessert on addition of a liquid such as milk or water), sweet bakery products (including, but not limited to, biscuits, cakes, rolls, pies, pastries, and cookies), pre-made sweet bakery mixes for preparing sweet bakery products (preferably in powdered form), pie fillings (including, but not limited to, fruit pie fillings and nut pie fillings such as pecan pie filling) , a cereal product such as sweetened breakfast cereals (including, but not limited to, extruded (kix type) breakfast cereals, flaked breakfast cereals and puffed breakfast cereals), cereal coating compositions, baked goods including bread products (including, but not limited to, leavened and unleavened breads, yeasted and un-yeasted breads such as soda breads, breads comprising any type of wheat flour, breads comprising any type of non-wheat flour (such as potato, rice and rye flours), gluten-free breads), pre-made bread mixes for preparing bread products (preferably in powdered form) and other pre-made savoury bakery mixes for preparing savoury bakery products, frozen dairy products, meats, dairy products, condiments, snack bars (including, but not limited to, cereal, nut, seed and/or fruit bars), soups, dressings, mixes, prepared foods, baby foods, diet preparations, syrups, food coatings, dried fruit, sauces, gravies, spreads (including, but not limited to, jams/jellies butters and other spreadable preserves, conserves and the like). Other types of food product not mentioned here but which conventionally include one or more nutritive sweetener may also be contemplated in the context of the present invention, especially those which are reduced sugar or low sugar products. The food product may be an animal feed product. The food product of the invention may comprise the sweetener composition as a coating or frosting formed on the surface of the product. This coating may improve the flavour of the food product as well as its shelf life.

Food precursors are preferred, such as bakery mixes (sweet and savoury) and powdered dessert mixes.

Non-limiting examples of a beverage product include a carbonated beverage (including, but not limited to, soft carbonated beverages), a non-carbonated beverage (including, but not limited to, soft noncarbonated beverages such as flavoured waters and sweet tea or coffee based beverages), fruit-flavoured beverage, fruit-juice, tea, milk, coffee, especially those which are reduced sugar or low sugar products. Other types of beverage product not mentioned here but which conventionally include one or more nutritive sweetener may also be contemplated in the context of the present invention, especially those which arte reduced sugar or low sugar products.
Examples of non-carbonated and carbonated beverage products include cola, diet cola, soda, diet soda, citrus flavoured drinks such as orange flavoured drinks (e.g. orangeade) or lemon flavoured drinks (e.g. lemonade), juice cocktail, root beer, birch beer, any fountain drink, sparkling fruit juice, water, sparkling water, tonic water, sport drink, and club soda.
Beverage products may also include non-alcoholic (soft) or alcoholic drinks such as any beer, including ale, pilsner, lager, or derivation thereof, malt liquor, red wine, white wine, sparkling wine, fortified wine, wine cooler, wine spritzer, any pre-made cocktail mixer including margarita mix, sour mix, or daiquiri mix, any fermented fruit or tea beverage, hard liquor, and any flavoured liqueur such as brandy, schnapps, bitters, or cordial.
Beverage products may include any dairy, milk, or cream product or any dairy, cream, or milk substitute such as half & half, non-dairy creamer, powdered creamer, flavoured creamer, soy milk product, and lactose-free milk product.
Beverage products may also include any fruit or vegetable juice in whole, concentrated, or powdered form and any combination of fruit and vegetable juices or other beverages.
Beverage products may also include coffee, any coffee drink, any coffee flavouring syrup, tea, iced tea, and cocoa, as well as any combination of any of the foregoing.
Beverage products may also include beverage precursors, which are processed into a beverage by the consumer. Such precursors may be processed into a beverage by addition of a liquid (e.g. still or carbonated water, milk), and may be referred to as “pre-mix” products. The beverage precursors may be provided in the form of a liquid concentrate, or in solid form which may be in powdered or tabletted form. Beverage precursors may be precursors for alcoholic drinks or soft drinks. Beverage precursors for soft drinks may for soft drinks that are cold drinks (including fruit flavoured soft drinks and supplement drinks such as high-energy or high-protein sports drinks) or hot drinks (e.g. tea, cocoa, hot chocolate, coffee). An example beverage precursor may be a 3-in-1 coffee product, which includes a sweetener, coffee and a dairy or non-dairy creamer.

Beverage products incorporating the sweetener composition defined herein are preferred. Non-alcoholic beverage products are favoured. Soft, non-carbonated and beverage products are particularly favoured, particularly beverage precursors for such beverages.

The invention also provides for the use of the sweetener composition defined herein in a food product or beverage product (as a sweetener). The food product may be a food (i.e. ready for consumer consumption) or it may be a food precursor (i.e. a product which the consumer processes into a food). The beverage product may be a beverage (i.e. ready for consumer consumption) or it may be a beverage precursor (i.e. a product which the consumer processes into a beverage). Food and beverage precursors may be provided in the form of a liquid concentrate, or in solid form, suitably as a tablet or powder. Food and beverage precursors in powdered form are preferred.

The invention also provides a method of making a food product or beverage product comprising incorporating the sweetener composition defined herein. The food product may be a food (i.e. ready for consumer consumption) or it may be a food precursor (i.e. a product which the consumer processes into a food). The beverage product may be a beverage (i.e. ready for consumer consumption) or it may be a beverage precursor (i.e. a product which the consumer processes into a beverage). Food and beverage precursors may be provided in the form of a liquid concentrate, or in solid form, suitably as a tablet or powder. Food and beverage precursors in powdered form are preferred.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The invention will now further be described by reference to the following non- limiting Examples.

### EXAMPLES

In the following Examples 1-4, agglomerated sweetener compositions were made by agglomerating maltodextrin (DE=6) and micronized sucralose in a Lodige LFP mini 2 agglomerator with the nozzle insert in the top spray configuration.

### Example 1

### 30% Sucralose, the Whole Sucralose Content being Dissolved in Solution

143 g of Maltodextrin were placed into the fluid bed and agglomerated with 600 g of a solution consisting of 143 g Maltodextrin, 114 g Sucralose Micronized and 400 g of Water. The process was operated with the following parameters:

| | | |
|---|---|---|
| Product Temp. | 42° | C. |
| Air Volume | 80 | m³/hr |
| Air Temp | 90° | C. |
| Atomization Air | 1 | bar |
| Spray Rate | ~7 | g/min |

After all of the solution was sprayed, the pump and heater were shut off and the product dried for 1 minute. The finished product was discharged from the chamber and sieved through a 1 mm screen to remove large particles.

### Example 2

### 30% Sucralose, Half of the Total Sucralose Content in Solution & Half of the Sucralose Content as Primary Material

143 g of Maltodextrin and 57 g Sucralose Micronized were placed into the fluid bed and agglomerated with 500 g of a solution consisting of 143 g Maltodextrin, 57 g Sucralose Micronized and 300 g of Water. The process was run with the following parameters:

| | | |
|---|---|---|
| Product Temp. | 42° | C. |
| Air Volume | 80 | m³/hr |
| Air Temp | 90° | C. |
| Atomization Air | 1 | bar |
| Spray Rate | ~7 | g/min |

After all of the solution was sprayed, the pump and heater were shut off and the product dried for 1 minute. The finished product was discharged from the chamber and sieved through a 1 mm screen to remove large particles.

### Example 3

### 10% Sucralose/90% Maltodextrin: Whole Sucralose in Solution

180 g of Maltodextrin were placed into the fluid bed and agglomerated with 520 g of a solution consisting of 180 g Maltodextrin, 40 g Sucralose Micronized and 300 g of Water. The process was run with the following parameters:

| | | |
|---|---|---|
| Product Temp. | 42° | C. |
| Air Volume | 80 | m³/hr |
| Air Temp | 90° | C. |
| Atomization Air | 1 | bar |
| Spray Rate | ~7 | g/min |

After all of the solution was sprayed, the pump and heater were shut off and the product dried for 1 minute. The finished product was discharged from the chamber and sieved through a 1 mm screen to remove large particles.

### Example 4

### 50% Sucralose/50% Maltodextrin: All Sucralose in Syrup

143 g of Maltodextrin were placed into the fluid bed and agglomerated with 1029 g of a solution consisting of 143 g Maltodextrin, 286 g Sucralose Micronized and 600 g of Water (Room temperature). The process was run with the following parameters:

| | | |
|---|---|---|
| Product Temp. | 42° | C. |
| Air Volume | 80 | m³/hr |
| Air Temp | 90° | C. |
| Atomization Air | 1 | bar |
| Spray Rate | ~7 | g/min |

After all of the solution was sprayed, the pump and heater were shut off and the product dried for 1 minute. The finished product was discharged from the chamber and sieved through a 1 mm screen to remove large particles.

### Example 5

### Characterisation of the Agglomerates

The water content of the agglomerates was determined by Karl Fischer analysis, using a Karl Fischer titrator (Composite 2 reagent).

Particles size was determined with a Beckman Coulter LS320 Laser diffraction analyser.

The density was obtained with a Erweka densi-volumenomer using a graduated test tube of 250 ml.

The samples in the following table (prepared according the foregoing Examples 1 to 4) were analysed:

| | | | mean | Water |
|---|---|---|---|---|
| | Sample | density | particle | content |
| | name | (g/l) | size (μm) | wt % |
| 30% sucralose/ | HALF30 | 330 | 194 | 3.24 |
| 70% maltodextrin, half | | | | |
| sucralose dissolved in solution | | | | |
| 30% sucralose/ | ALL30 | 352 | 213 | 4.46 |
| 70% maltodextrin, whole | | | | |
| sucralose dissolved in solution | | | | |
| 10% sucralose/ | ALL10 | 330 | 234 | 4.38 |
| 90% maltodextrin, whole | | | | |
| sucralose dissolved in solution | | | | |
| 50% sucralose/ | ALL50 | 455 | 257 | 3.72 |
| 50% maltodextrin, whole | | | | |
| sucralose dissolved in solution | | | | |

### Example 6

### Thermal Stability of the Agglomerates

The agglomerates produced were exposed to accelerated ageing in an oven set at 50° C. in air-tight packaging preventing water loss. Samples were taken out of the oven on a regular basis and analysed for pH, colour (Whiteness and Yellowness), sucralose content and 4-chlorogalactose content.

Sucralose content was determined by HPLC. The pH was measured after dilution at 10% concentration (weight/weight) in water previously adjusted to pH=6 with diluted sodium hydroxide/hydrochloric acid solutions. A rapid drop in pH is an indicator of sucralose degradation. The Hunter colour was determined with a Hunterlab colour measurement instrument. Whiteness and yellowness values may be calculated according to ASTM E313. 4-chlorogalactose is a by-product of sucralose thermal degradation. Its content was determined by ion chromatography using separation on a carbohydrate anion exchange column with a gradient of sodium hydroxide and sodium acetate and detection by pulsed amperometric detection (HPAE-PAD).

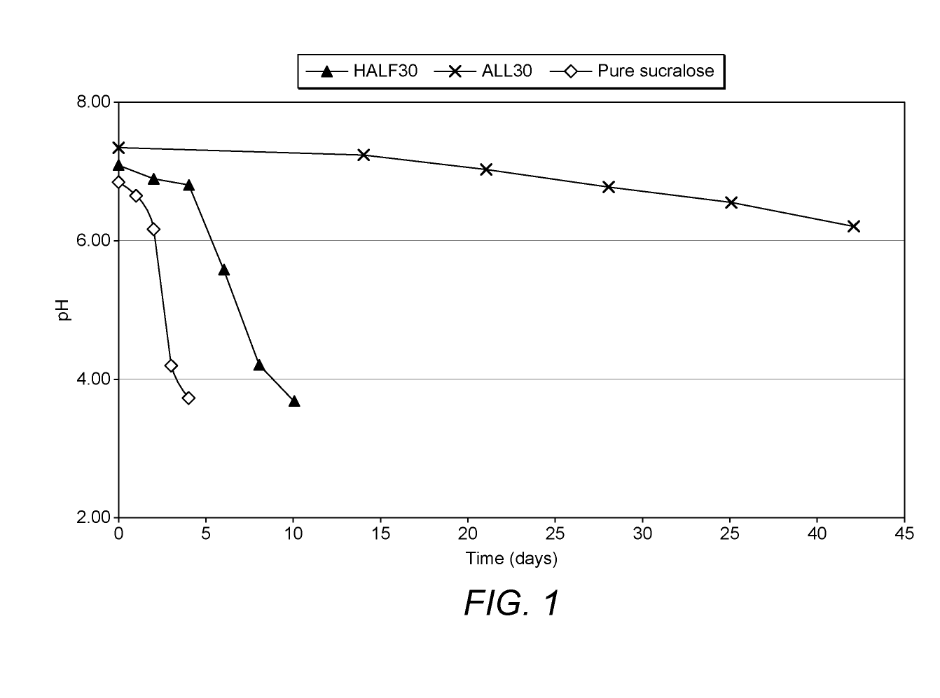

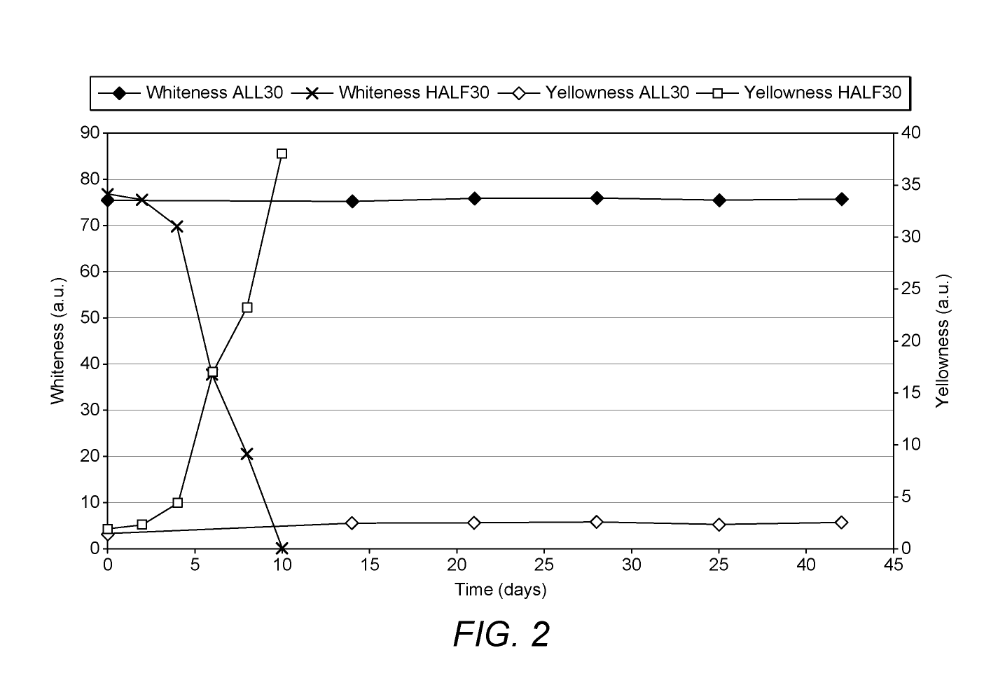

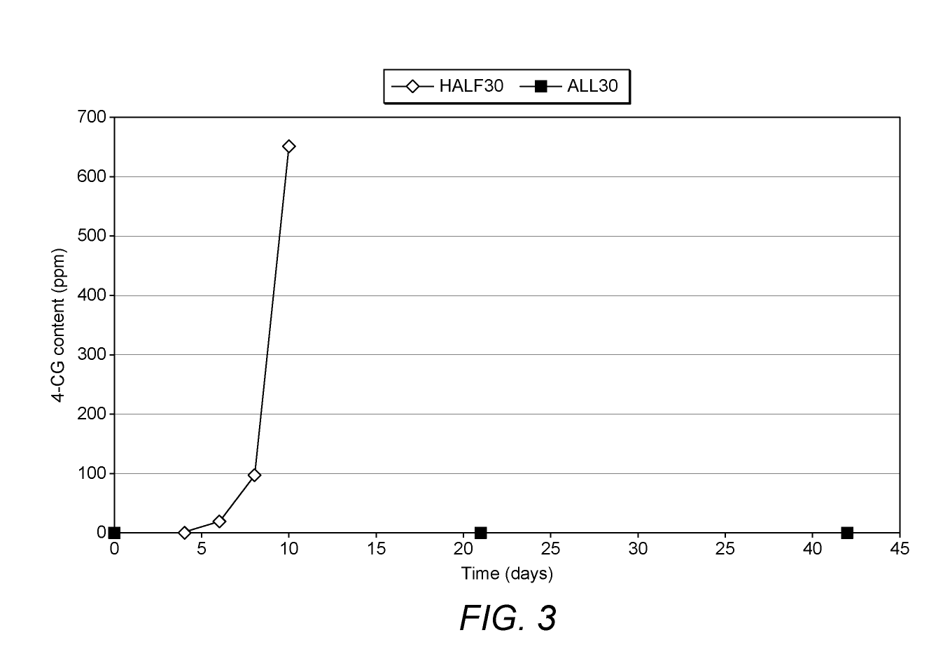

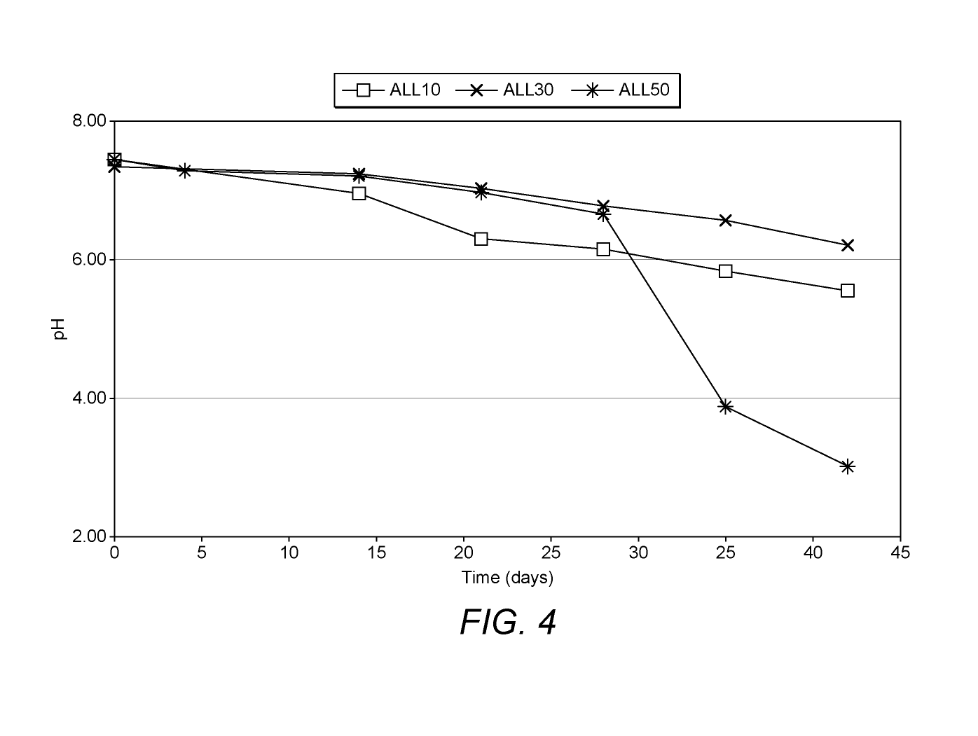

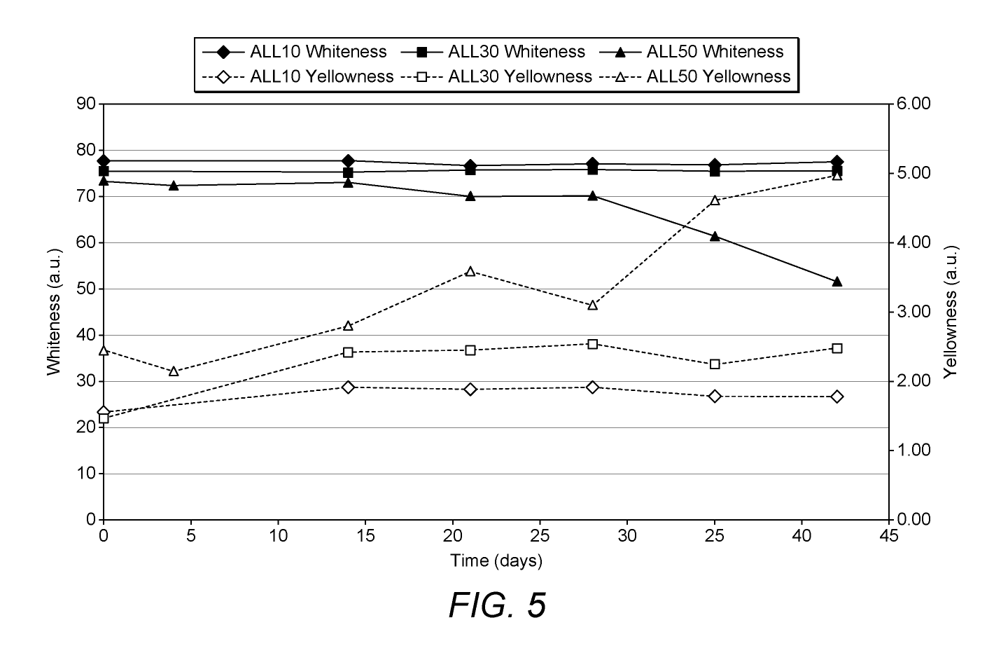

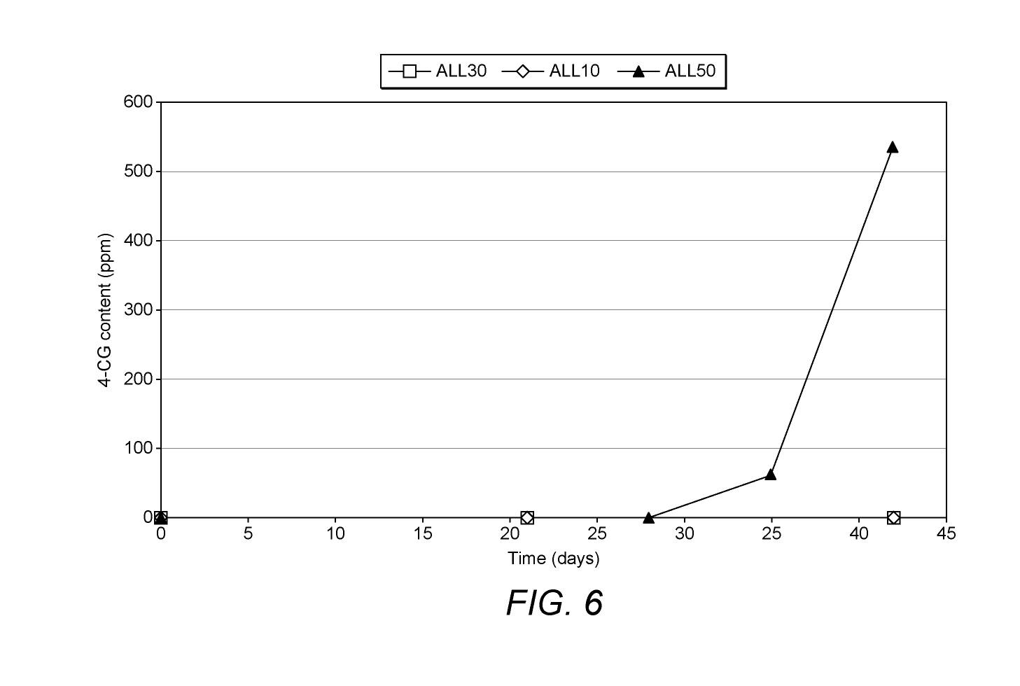

The results are shown in FIGS. 1 to 6. The results for the samples where the sucralose was fully dissolved in the coating solution are summarised in the following table:

| Sample | pH | Whiteness | Yellowness | 4-CG |
|---|---|---|---|---|
| ALL10 | Slow decrease | Stable over | Stable over | Stable |
| | after 15 days | >42 days | >42 days | over |
| | | | | >42 days |
| ALL30 | Slow decrease | Stable over | Stable over | Stable |
| | after 15 days | >42 days | >42 days | over |
| | | | | >42 days |
| ALL50 | Drops after 30 | Drops after 30 | Between 20 and | 28 days |
| | days | days | 35 days | |

By contrast, the sample HALF30 displayed rapid degradation according to all tests.

### Example 7

### Long-Term Stability Testing

Agglomerated particles according to the invention were prepared in an analogous manner to example 1 (with the whole Sucralose content being dissolved in solution during the preparation process), except that the final product has a composition of 24.5% sucralose and 75.5% maltodextrin (on a dry weight basis).

The resulting agglomerates were exposed to accelerated ageing in an oven set at 50° C. in air-tight packaging preventing water loss. Samples were taken out of the oven on a regular basis and analysed for colour (whiteness and yellowness) and sucralose content.

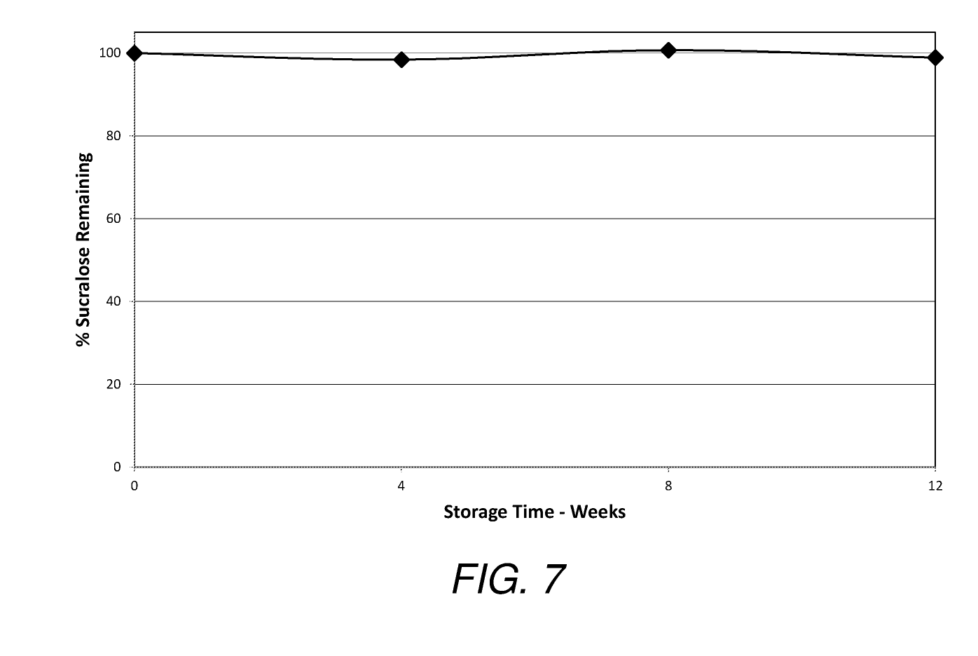

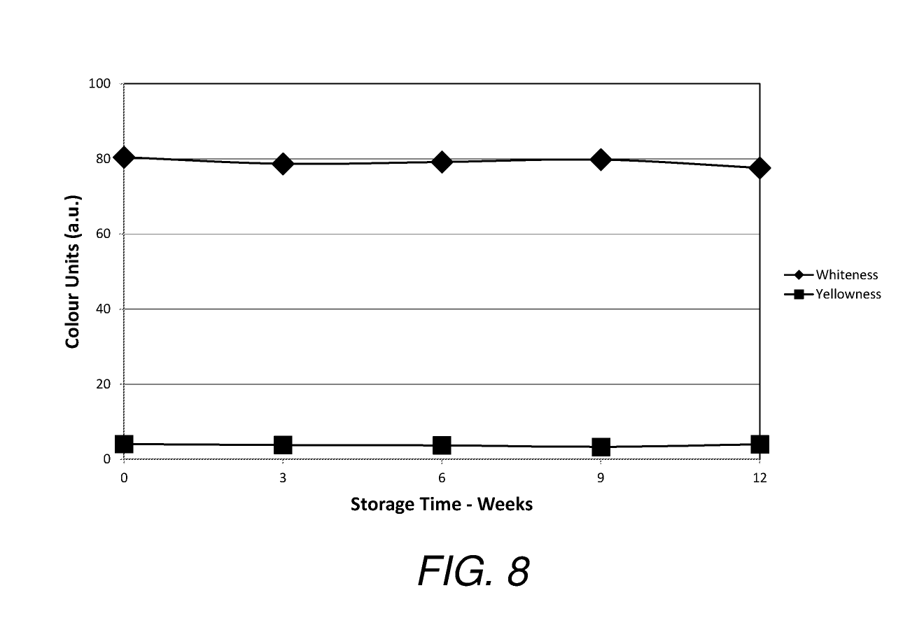

The results are shown in FIGS. 7 and 8. Substantially no change in the sucralose content or colour is observed over a period of 12 weeks.

### Example 8

### Powdered Beverage Precursor

Agglomerated particles according to the invention were incorporated into an orange flavoured powdered beverage precursor. The powdered mix had the following composition:

| Ingredient | % (dry weight basis) |
|---|---|
| Maltosweet 180 [RTM] | 49.673 |
| Agglomerated particles | 4.713 |
| Orange flavor | 6.539 |
| Cloudifier (E171) | 5.377 |
| Anhydrous citric acid | 31.082 |
| Tartazine E102 85% | 0.079 |
| Sunset Yellow E110 85% | 0.228 |
| Monohydrate Monophosphate calcium | 2.308 |

Maltosweet 180 [RTM] is a maltodextrin (DE=18) available from Tate & Lyle.

The resulting powdered composition was exposed to accelerated ageing in an oven set at 50° C. in air-tight packaging preventing water loss. Samples were taken out of the oven on a regular basis and analysed for sucralose content.

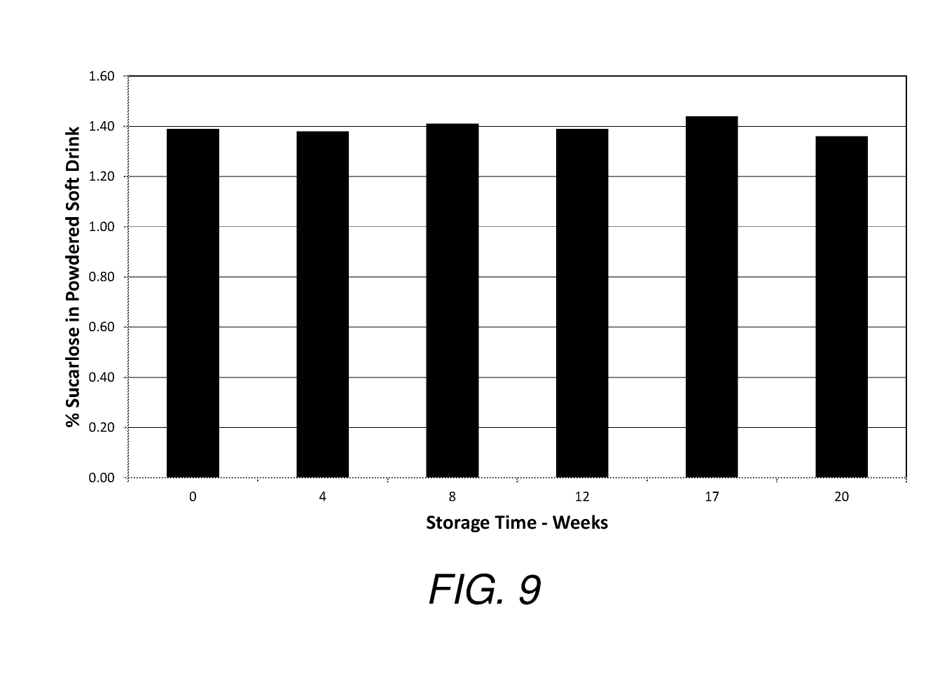

The results are shown in FIG. 9. Substantially no change in the sucralose content of the powdered soft drink (PSD) beverage precursor is observed over a period of 20 weeks.

### Example 9

### Pilot Scale Production

7 kg maltodextrin (DE=6) (Maltosweet 060 [RTM]) was placed in the bed of a Glatt GF20 fluid bed agglomerator and agglomerated with 28.8 kg liquid binder containing 5 kg sucralose (granular), 6.22 kg Maltosweet 060 [RTM], and 17.57 kg water.

The operational parameters are described in the table below:

| | | |
|---|---|---|
| Product Temp. | 47.9-48.1° | C. |
| Air flow | 900 | kg/h |
| Air Temp | 67-68° | C. |
| Atomization Air | 3.3-3.6 | bar |
| Spray Rate | 6-7 | m³/h |

| | |
|---|---|
| Binder feed rate | 6-6.3 kg/0.5 h |
| Dry feed rate | 1.3 kg/0.5 h |

The product obtained had the following properties:

| | |
|---|---|
| Moisture content (%) | 6.08-6.35 |
| Mean particle size (μm) | 250-400 μm |
| Loose density (g/l) | 600-650 |

This pilot scale process resulted in a product with significantly higher bulk density than the smaller scale processes of Examples 1-4.

1. A sweetener composition comprising agglomerated particles, each particle including:
one or more core particles, each consisting of a first carrier substance having a relative sweetness of less than 0.3 and present in an amount of from 45 to 10% by weight of the composition;
a coating disposed around the one or more core particles, the coating comprising:
a second carrier substance having a relative sweetness of less than 0.3 and present in an amount of from 45 to 10% by weight of the composition; and
a high intensity sweetener having a relative sweetness of greater than 100 and present in an amount of from 10 to 80% by weight of the composition.

2. A composition according to claim 1, wherein the high intensity sweetener comprises sucralose.

3. A composition according to claim 2, wherein the high intensity sweetener is sucralose.

4. A composition according to claim 1, wherein the first carrier substance is maltodextrin.

5. A composition according to claim 1, wherein the second carrier substance is maltodextrin.

6. A composition according to claim 1, wherein the mean particle size of the agglomerated particles is between 200 and 400 μm.

7. A composition according to claim 1, wherein the composition contains water in an amount of less than 8% by weight of the composition.

8. A composition according to claim 1, wherein the coating further comprises a buffer.

9. A composition according to claim 1, wherein the agglomerated particles comprise substantially no components which have a relative sweetness in the range of about 0.7 to about 5.

10. A composition according to claim 1, comprising substantially no sucrose.

11. A method of making a sweetener composition according to claim 1, the method comprising:
preparing a coating solution comprising the second carrier substance and the high intensity sweetener dissolved in water;
applying the coating solution to the core particles under conditions which moisten the core particles with the coating solution; and
drying the resulting mixture to afford a sweetener composition according to claim

12. A method according to claim 11, wherein the coating solution further comprises a buffer.

13. A food product or beverage product incorporating the sweetener composition of claim 1.

14. A food product or beverage product according to claim 13 which is a food precursor or beverage precursor.

15. A method of making a food product or beverage product, comprising using a sweetener composition in accordance with claim 1.

16. The usemethod according to claim 15 wherein the food product or beverage product is a beverage precursor or food precursor.

17. A composition according to claim 1, wherein the first carrier substance is present in an amount of from 45 to 25% by weight of the composition, the second carrier substance is present in an amount of from 45 to 25% by weight of the composition, and the high intensity sweetener is present in an amount of from 10 to 50% by weight of the composition

18. A food product or beverage product according to claim 13 which is a food precursor or beverage precursor in solid form.

19. The method according to claim 15 wherein the food product or beverage product is a solid beverage precursor or solid food precursor.
